(19) United States
(12) Patent Application Publication
(10) Pub. No.: US 2002/0121042 A1
(43) Pub. Date: Sep. 5, 2002

(54) Arm cradle for fishing rod and similar elongated poles and rods

(76) Inventor: Michael Macaluso, Mamaroneck, NY (US)

Correspondence Address: LACKENBACH SIEGEL, ONE CHASE ROAD, SCARSDALE, NY, 10583, US

(21) Appl. No.: 09/955,454

(22) Filed: Sep. 18, 2001

Related U.S. Application Data
(63) Continuation-in-part of application No. 09/427,408, filed on Oct. 25, 1999, now Pat. No. 6,295,755.

(51) Int. Cl. A01K 97/10

(52) U.S. Cl. 43/21.2

(57) ABSTRACT

There is provided an adjustable arm supporting device for attachment to an elongated handle for the purpose of assisting the user to hold, support, and/or use a tool attached to the end of the elongated handle. The adjustable arm supporting device has a cradle for the forearm of a user, a handle support holding the cradle in an ergonomic alignment with the elongated handle. Preferably, the adjustable arm supporting device is self-adjusting in response to pressures exerted on it by the user and/or the tool.

### RELATED APPLICATIONS

The present invention is a continuation-in-part of U.S. patent application Ser. No. 09/427,408, filed on Oct. 25, 1999.

### BACKGROUND OF THE INVENTION

1. Field of the Invention

The present invention relates generally to fishing rods, as well as to devices that assist a user to hold and/or support pole shaped articles.

2. Description of the Prior Art

A spinning-type fishing rod has a long, flexible rod that creates unusual stresses on the arm of the fisherman when a fish has struck the bait and the fisherman must both fight the strength of the struggling fish and eventually struggle to reel in the fish. The arm of the fisherman is aligned at an unnatural angle during the time of maximum leverage when the rod is being pulled upwardly during a strike and likewise during the time the fisherman is reeling in the fish. Stresses are typically concentrated on the forearm of the fisherman and in particular in the wrist area of the forearm. It is apparent that as the forearm of the fisherman becomes aligned with the handle of the rod, the wrist area becomes bent at an angle relative to the rest of the forearm as pressure grows during strike activity and the fishing rod is being pulled upwardly so that unusual stress is concentrated at the sharply bent wrist, which restricts blood circulation at the wrist.

Prior art that has attempted to overcome the problem of forearm and wrist stress while fishing with a spinning rod includes patents that have the object of supporting the forearm of a fisherman holding a long fishing rod. U.S. Pat. No. 4,014,129 issued to Capra on Mar. 29, 1977, provides a fishing rod stabilizing handle which directly replaces the conventional posterior rod handle of the spinning rod or which is configured as an attachment for engagement to the conventional posterior handle. The rod stabilizing handle of is a broad upwardly directed elongate surface projecting from one side of the handle for alignment with and direct engagement of a substantial length of the underside of the forearm portion of the fisherman. U.S. Pat. No. 5,390, 438, issued to Warren, Jr. on Feb. 23, 1995, describes an arm support for stabilizing a fishing rod on the arm of a fisherman and for removing at least some of the playing pressure of a fish or heavy lures from the fisherman's wrist while the fisherman is playing the fish on a fishing line extending from a reel mounted on the fishing rod, which arm support includes an elongated straight portion which protrudes rearwardly from fixed or removable attachment to the handle of the fish rod and a generally C-shaped curved portion including multiple, short, straight rod segments connected together and shaped to fit beneath the forearm of the fisherman. One end of the curved portion is positioned under the fisherman's wrist and the other end is located under the forearm so that the curved portion exerts pressure upwardly against the fisherman's wrist and forearm. U.S. Pat. No. 5,313,735 issued to Latouch on May 24, 1994 discloses a splined shaft 22 glued or otherwise affixed to a fishing rod handle 12 and an arm bearing extension 16 having a splined coupling 22 splined onto splined shaft 22. Splines that run on the outside of added shaft 12 cooperate with splines that run on the inside surface of a cylindrical hole to prevent rotation of the fishing rod relative to the extension. The rod can be withdrawn from the extension and rotated and then be reinserted into spline locking relationship with the extension at a new orientation. The necessity of having a special splined shaft 22 more or less permanently affixed to the fishing rod handle greatly limits the range of usability of the Latouch invention. U.S. Pat. No. 3,372,510 issued to Arsenault on Mar. 12, 1968, discloses a hand grip and an arm support disposed in the axial direction of a fishing rod and connected to the rod handle.

Applicant's U.S. patent application Ser. No. 09/427,408 describes devices supporting the arm of a fisherman using a spinning-type fishing rod having a cylindrical rod handle comprising an adjustable rotatable arm cradle supporting the upper forearm of the fisherman, a partially cylindrical elongated handle support member defining a partially cylindrical compartment that holds a selected area of the fishing rod handle in alignment with the arm cradle, an adjustable post connecting the arm cradle means with the handle, and an adjustable clamp for removably gripping the rod handle to the handle support.. The arm cradle is rotatable to a selected angle relative to the rod handle and is removably lockable at the selected angle. The connecting post can be lengthened or shortened to a selected position and removably locked at that position. The clamp that presses the fishing rod handle against the top of the holding compartment of the handle support member is adjustable by means of a vertical screw that raises or lowers the clamp. U.S. patent application Ser. No. 09/427,408 is incorporated by reference in their entirety into the present application.

Applicant's U.S. patent application Ser. No. 09/595,125 provides a device supporting the arm of a fisherman using a spinning-type fishing rod having a cylindrical rod handle providing a gripping area for the hand of the fisherman that comprises a cradle member supporting the upper forearm of the fisherman and a rod handle support member holding the fishing rod handle in alignment with the cradle member. The rod handle support member is positioned below and rotatably connected with the cradle member about a horizontal axis of rotation. The handle support member and the cradle member are each rotatable about the horizontal axis to a plurality of positions in response to pressure applied to said cradle member and the rod handle support member. A clamp attached to the rod handle support member removably grips the rod handle to the handle support member. Self-adjusting positioning means both locks said cradle means with the handle support member at any of a plurality of positions at a locked position wherein the forearm is in a comfort zone and further unlocks the cradle member and the handle support member from the locked position both in response to pressure exerted by the forearm to find a new comfort zone and in response to pressure associated with the fishing rod during fishing that in turn exerts pressure on the rod handle support member. The fishing rod handle gripping compartment and the arm cradle compartment each have an axis positioned in a vertical planes that are offset from one another with the vertical plane of the cradle compartment being nearer to the torso of the fisherman so as to allow the fisherman to hold the fishing rod handle from under the handle. U.S. patent application Ser. No. 09/595,125 is incorporated by reference in their entirety into the present application.

Fishing rods are just one of the many types articles and tools that are have elongated and/or pole-shaped handles. Common tools with elongated and/or pole-shaped handles include: painter's poles, mop handles, rakes, hoes, crow bars, shovels, tree saws and clippers, window washers and squeegees, and water sprayers and nozzles. Potentially injurious stresses are placed on the arm any time the arm of the user is holding the pole-shaped handle at maximum extension. Another potentially injurious situation is when maximum leverage is being exerted against a weight, since the arm of the user is often under excessive strain while aligned at an unnatural angle. When using long poles, the stresses are typically concentrated on the forearm of the user and, in particular, in the wrist. Thus, there is a need for a device that assist a user in supporting and using any type of elongated, pole-shaped, and/or rod-shaped article or tool.

The present invention will be better understood and the objects and important features, other than those specifically set forth above, will become apparent when consideration is given to the following details and description, which when taken in conjunction with the annexed drawings, describes, illustrates, and shows preferred embodiments or modifications of the present invention and what is presently considered and believed to be the best mode of practice in the principles thereof.

Other embodiments or modifications may be suggested to those having the benefit of the teachings therein, and such other embodiments or modifications are intended to be reserved especially as they fall within the scope and spirit of the subjoined claims.

### DESCRIPTION OF THE DRAWINGS

FIG. 1 is a side elevational view of an adjustable arm support device for a fisherman in accordance with the present invention holding a spinning-type casting rod with portions of the fisherman, the fishing rod and spinner shown in phantom line, and an arm cradle supporting the forearm with the hand of the fisherman holding the handle of the fishing rod in the palm of the hand;

FIG. 2 is a perspective view of the adjustable arm support in a assembled mode seen generally as a front view;

FIG. 3 is an exploded perspective, or disassembled, view taken generally as a front view of the adjustable arm support device shown in FIGS. 1 and 2;

FIG. 4 is a rear view of the adjustable arm support shown in FIGS. 1, 2, and 3 in an assembled mode with the fishing rod handle shown in phantom line being gripped by the rod clamp also shown in phantom line and further showing the offset between the arm cradle member and the rod handle support member;

FIG. 5 is a rear view of the adjustable arm support similar to the view shown in FIG. 4 with a portion of the swivel wall having been stripped away revealing the inner structure of the automatic swivel including the biasable fingers and the swivel teeth and also showing the resilient plug;

FIG. 5A is a cross-sectional view taken through line 5A-5A of FIG. 5;

FIG. 5B is an enlarged view of the automatic swivel as shown in FIG. 5 taken in isolation;

FIG. 6 is a bottom view of the adjustable arm support;

FIG. 7 is top view of the adjustable arm support;

FIG. 8 is a side view taken through plane 8-8 of FIG. 2;

FIG. 9 is an isolated enlarged view of a portion of the cross-sectional view of FIG. 5A showing one of the locking ribs of one of the biasable fingers engaged with the teeth of the swivel;

FIG. 9A shows a view similar to the cross-sectional view of FIG. 8 with the cradle having been slightly rotated towards a new locking position and the biasable finger shown in FIG. 9 being rotated to a new locking position so that the locking rib shown in FIG. 9 is temporarily positioned at the crown of one of the swivel teeth with the biasable rib in a temporary biased mode pressing into the resilient rubber plug which itself is being biased;

FIG. 10 shows in isolation the set of four biasable locking fingers each integral with the lower flange of the cradle shown in a cutaway view with two of the locking fingers having elongated locking ribs for engagement with the teeth of the swivel;

FIG. 11 shows in isolation a view analogous to the view shown in FIG. 10 with two of the locking teeth having locking pins for engagement with the teeth of the swivel;

FIG. 12 is a view taken through plane 12-12 of FIG. 10; and

FIG. 13 is an abstract side view illustrating various possible angles between cradle member 26 and rod handle support member 28.

FIG. 14 is a perspective view of an arm cradle according to the present invention that is fixedly attached to an elongated rod or pole-shaped handle;

FIG. 15 is a perspective view of an arm cradle according to the present invention that is removeably attached to an elongated rod or pole-shaped handle;

FIG. 16 shows the arm cradle of FIG. 14 in use attached to a long handled shovel;

FIG. 17 shows the arm cradle of FIG. 14 attached to a mop handle;

FIG. 18 shows the arm cradle of FIG. 14 attached to the handle of a snow shovel/ice scrapper;

FIG. 19 shows the arm cradle of FIG. 14 attached to a long handled squeegie;

FIG. 20 shows the arm cradle of FIG. 14 attached to the handle of a broom;

FIG. 21 shows the arm cradle of FIG. 1 attached to the handle of a fishing net;

FIG. 22 is a detail end view of an arm cradle according to the present invention that is adapted to be releasably attached by a screw-type clamping member to an elongated handle; and

FIG. 23 shows the arm cradle of FIG. 1 in use attached to an elongated water spray nozzle.

### DETAILED DESCRIPTION OF THE INVENTION

Reference is now made to the drawings in which identical or similar parts are designated by the same reference numerals throughout.

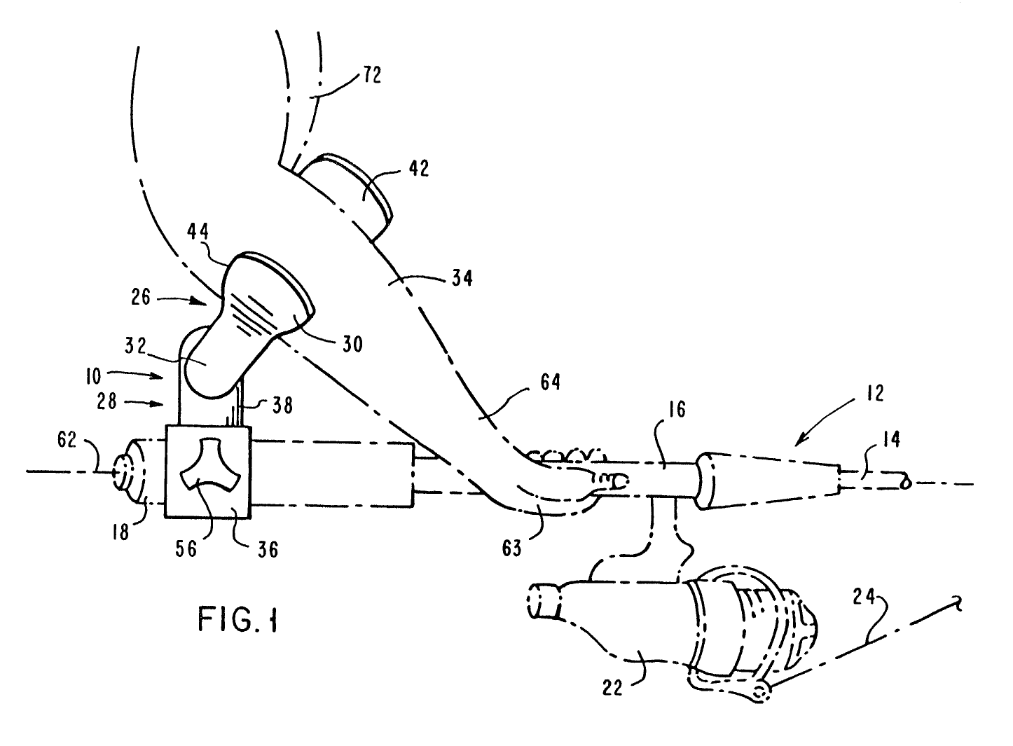

FIG. 1 shows an adjustable arm support device 10 supporting the arm of a fisherman using a spinning-type fishing rod 12 including a long metal rod 14, partially shown, and a cylindrical rod handle grip 16 connected to long rod 14 and a rod handle butt 18 positioned rearward of rod handle grip 16 each having handle cylindrical axis 20 and a line reel 22 positioned below rod handle grip 16 connected to a fishing line 24 that is clamped to rod handle grip 16 in a manner known in the art. Cylindrical axis 20 is shown in FIG. 1 as horizontal for purposes of exposition but can be aligned at a plurality of angles relative to the horizontal in a manner that will explained.

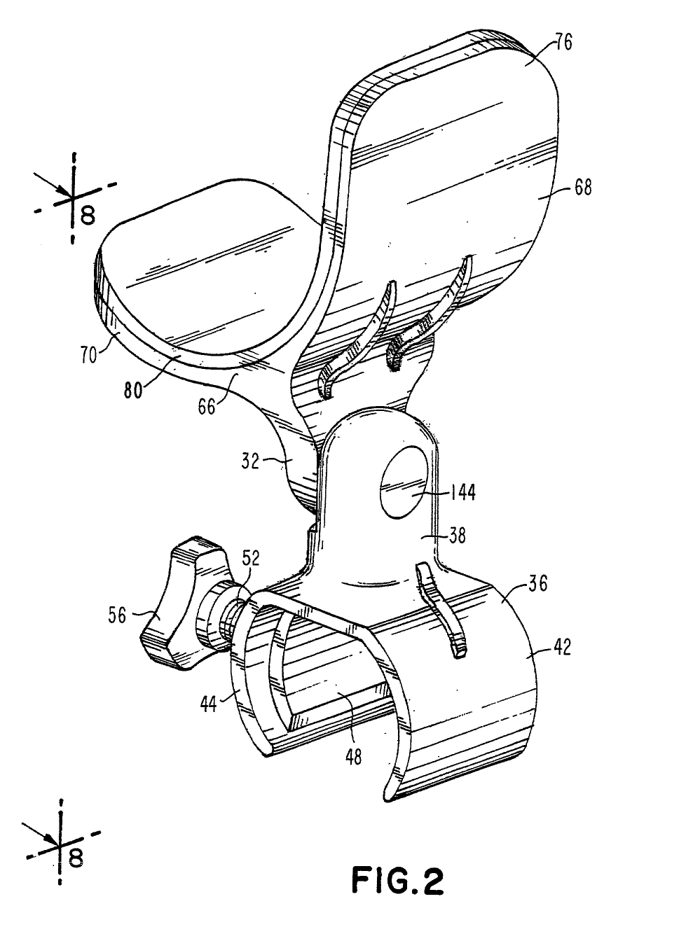

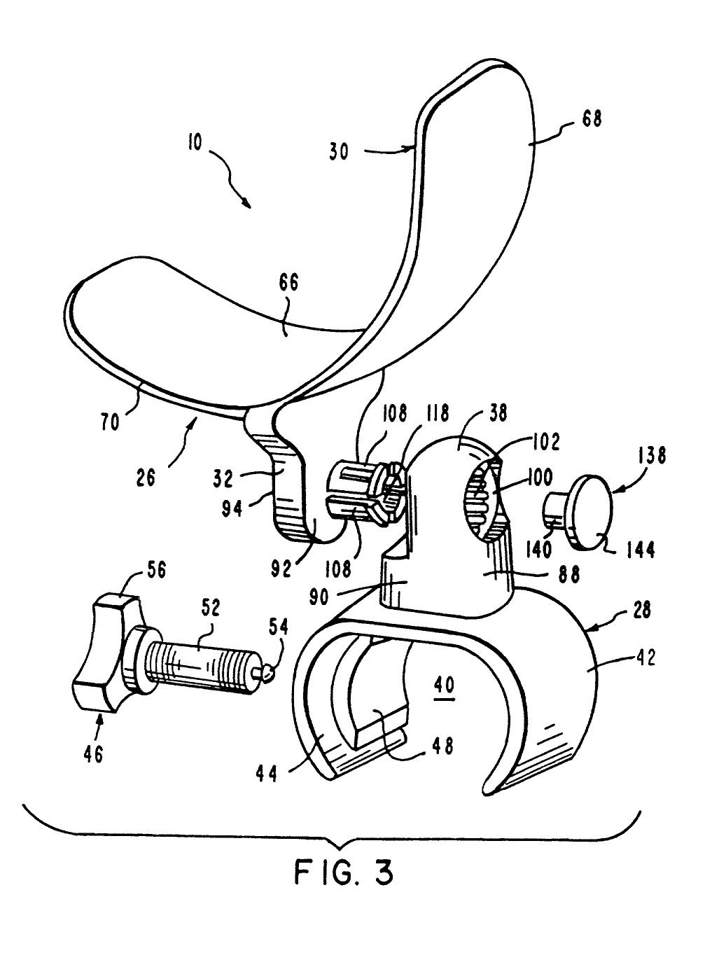

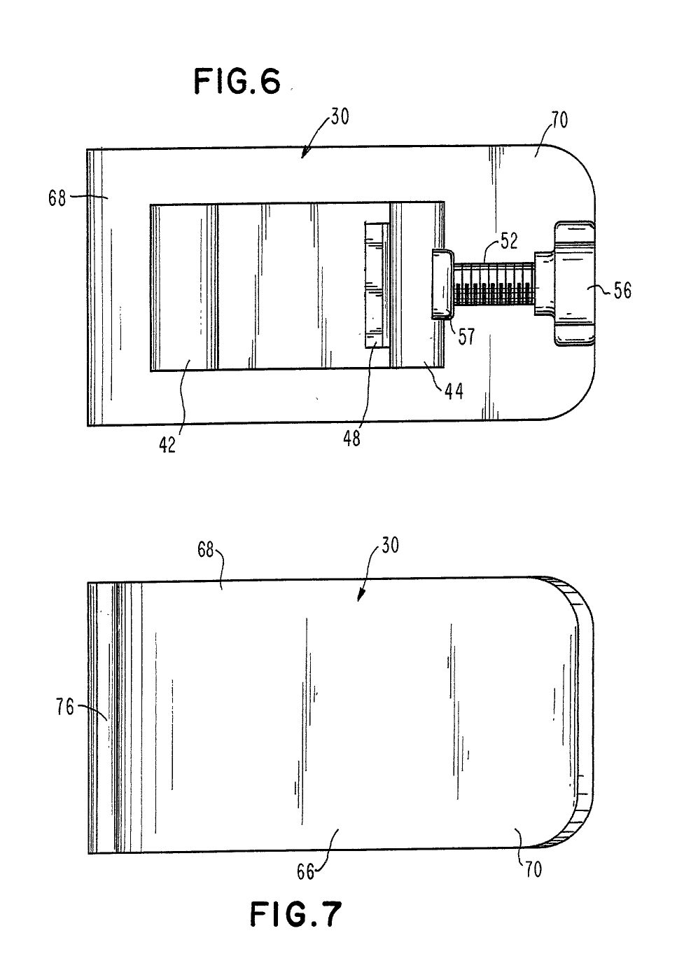

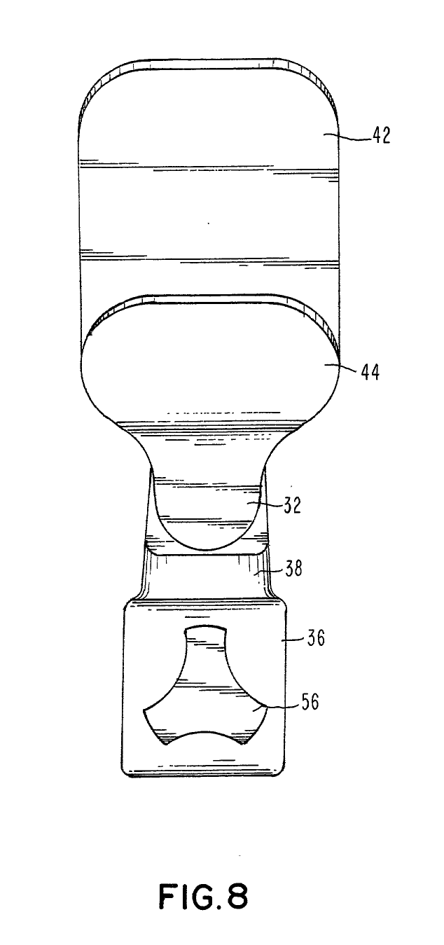

Arm support device 10, which is also shown in FIGS. 2-8 in entirety, comprises a cradle member 26 and a fishing rod handle support member 28. Cradle member 26 is rotatably secured to a fishing rod handle support member 28, both of which are also clearly seen in FIG. 3 in the disassembled view of adjustable arm support device 10.

Cradle member 26 includes an elongated arm cradle 30 and a cradle flange 32 unitary with the lower portion of arm cradle 30. Arm cradle 30 supports the upper forearm 34 of the fisherman, which in turn is lateral to the orientation of fishing rod 12.

FIG. 1 indicates that forearm 34 is the right forearm of the fisherman, but adjustable arm support device 10 as shown in FIGS. 1-11 is also mountable with the left forearm of a fisherman when arm support device 10 exactly as shown in the figures is reversed. When the left forearm of the fisherman is supported by arm support device 10, certain portions of device 10 are also reversed but device 10 is nonetheless operable at the left arm as well as the right arm as will be explained in detail later.

Fishing rod support member 28 includes a rod handle support 36 and a rod handle support flange 38 that is positioned above and unitary with rod handle support 36. Rod handle support flange 38 is rotatably connected to cradle flange 32 in a manner that will be explained in detail below. Rod handle support member 36 defines a handle holding compartment 40 that includes a convex arcuate handle holding compartment side wall 42 and an opposed convex arcuate handle compartment side wall 44.

Rod handle support member 28 further includes a clamp mechanism 46 that comprises a convex arcuate clamp wall 48 that is in convex arcuate alignment with compartment side wall 44, which defines a horizontal threaded bore 50. Clamp mechanism 46 further includes a threaded bolt 52 having a fastening end 54 and an opposed bolt head hand grip 56. Bolt 52 threadably extends through bore 50 with bolt fastening end 54 being secured to the center of clamp wall 48 in a manner known in the art, for example, by press fit. Bolt head hand grip 56 is positioned external to handle holding compartment 40 and in particular external to compartment side wall 44. Bolt head hand grip 56 is triangular in configuration so as to provide a hand grip for a fisherman for rotating bolt 52 in threaded bore 50 so that bolt 52 is threadably movable in selected inward or outward directions. Hand grip 56 can also be a knurled head, or thumb wheel, and can have other configurations such as a butterfly-type hand grip. When bolt 52 is threaded in the inward direction, bolt 52 presses clamp wall 48 inwardly so that fishing rod handle 16 is in a gripped position between arcuate compartment side wall 42 and clamp wall 48 in a rod handle cylindrical gripping compartment 58. When bolt 52 is threaded in the outward direction, clamp wall 48 is drawn outwardly away from rod handle 16 so that gripping compartment 58 as such is eliminated with the result that fishing rod 12 is free to be removed from handle holding compartment 40. A bolt locking nut 57 is threaded onto bolt 52 and positioned external to handle holding member outer side wall 44.

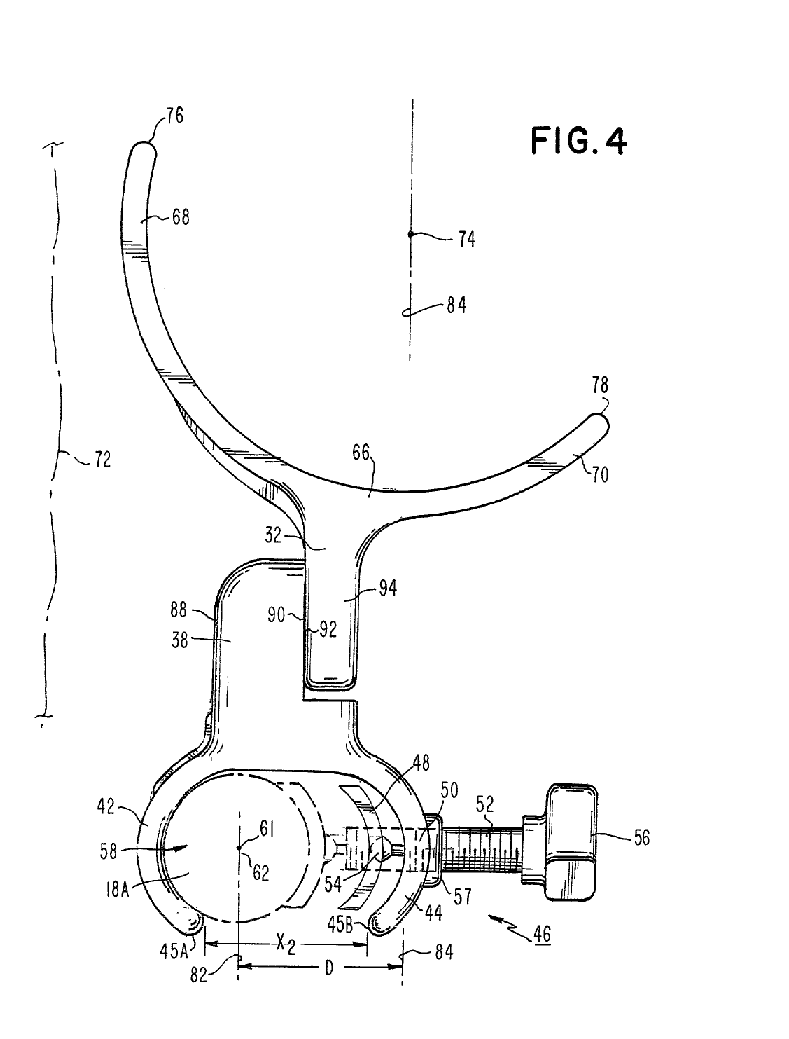

Rod handle support member 36 defines an aperture 59 that opens into handle holding compartment 40. Handle holding compartment side walls 42 and 44 have linear opposed lower edges 60A and 60B that in particular define aperture 59. The distance between linear lower side edges 60A and 60B is greater than the diameter of rod handle 16, which thus can be positioned in or removed from handle holding compartment 40 by sliding rod handle 16 through side aperture 59. Rod handle 16 can be positioned in holding compartment 40 by backing in butt end 18 into handle holding compartment 40. Fishing rod handle grip 16 has a fishing rod handle diameter X₁ indicated in FIG. 4, and handle holding compartment lower linear side edges 60A and 60B are spaced apart at a distance X₂ as indicated in FIG. 4 that is greater than the diameter of the diameter of fishing rod handle butt 18.

As seen in FIG. 4 and as shown in phantom line, rod handle 16 is positioned in gripping compartment 58, which is a subarea, or portion, of handle holding compartment 40 and which has a gripping compartment axis 61. Gripping compartment 58 is defined by handle holding compartment side wall 42 and arcuate clamp wall 48, shown in phantom line when clamp wall has been positioned towards rod handle butt 18A by threading bolt 52 inwards. Rod handle butt 18A has a rod handle axis 62 that is coextensive with gripping compartment axis 61. As seen in FIGS. 1 and 4, the hand 63 of the fisherman holds rod handle grip 16 with the wrist 64 of the fisherman positioned directly under rod handle grip 16.

Arm cradle 30, shown in FIG. 1 holding forearm 34, is also shown in the disassembled view of adjustable arm support device 10 in FIG. 3 and in the assembled view of adjustable arm support device 10 in FIGS. 2 and 4-8, comprises an arm cradle arced bottom portion 66 and a pair of opposed cradle inner and outer arced side wall portions 68 and 70, respectively, as positioned relative to torso 72 and which extend lateral to fishing rod 12. Cradle inner and outer side wall portions 68 and 70 extend upwardly from their respective opposed sides of cradle bottom portion 66 so as together to form a partial cylinder having a cradle axis 74. Cradle inner side wall portion 68 has an inner linear top edge 76 and cradle outer side arm portion 70 has an outer linear top edge 78. Inner top edge 76 is significantly higher than outer top edge 78, that is, side wall portion 68 is higher that side wall portion 70. Because pressure exerted by forearm 34 is naturally directed transversely toward torso 72, inner side wall portion 68 is preferably higher than outer side wall portion 70 so as to resist such lateral pressure.

A cradle cushion 80 is attached to the top side of cradle 26, particularly to the top sides of cradle bottom portion 66 and cradle inner and outer side wall portions 68 and 70. Cradle cushion 80 can be made of any suitable cushion material such as foam plastic with a waterproof cover. It is noted that self-adjusting arm support device 10 shown in the figures as supporting the right forearm 34 of a fisherman can also be reversed so as to support the left forearm of the fisherman (not shown). When device 10 reversed from the right arm to the left arm, cradle inner side wall portion 68 is again positioned adjacent to the torso 72 of the fisherman with the result that the higher cradle inner linear top edge 78 is positioned adjacent to the arm of the fisherman just as shown in the figures for the right arm positioning. In addition, clamp mechanism 46 is likewise positioned in the position away from torso 72 in the mirror image of the position of device 10 as shown throughout the figures. The net result is that adjusting arm support device 10 as shown in the figures is usable for the right arm exactly as shown for the left arm in the figures with no change of design.

As shown in FIG. 4, rod handle gripping compartment axis 61 lies in a vertical gripping compartment axis plane 82 and cradle axis 74 lies in a vertical cradle axis plane 84 that is generally parallel to and horizontally distanced from vertical gripping compartment axis plane 82. Vertical cradle axis plane 84, which is in general the center of the cross-section of forearm 34 of the fisherman, is located between torso 72 of the fisherman and vertical gripping compartment axis plane 82. Vertical cradle axis plane 84 and vertical gripping department compartment axis plane 82 are positioned at an offset distance D from one another. Thus, forearm 34 extends lateral to fishing rod 12 at transverse offset distance D from fishing rod 14 thus providing the structure that allows wrist 64 to be positioned outwardly from rod handle 16 relative to torso 72 so that hand 63 is naturally placed and wrapped around the underside of rod handle 16 to support the downward pressure from rod 14 as shown in FIG. 1. Thus, offset D provides the fisherman with the ergonomic advantage of supporting fishing rod 12 by way of hand 63 being positioned underneath rod 12. Offset distance D is slight and is intended not only to increase the comfort level of forearm 34, wrist 64 and hand 63 of the fisherman but also to increase the ergonomic efficiency of the body structure relative to holding fishing rod 12. The range of offset distance D can vary in accordance with the size of the fisherman, particularly forearm 34, wrist 64 and hand 63, but in general distance D can range between approximately ½ inch to 1¾ inch. For example, an offset distance of one inch can be provided.

A self-adjusting positioning mechanism 86 pivotally connects cradle member 26 with rod handle support member 28 providing mutual rotational capability between cradle member 26 and rod handle support member 28 between a plurality of rotational positions as will be explained. Self-adjusting positioning mechanism 86 is responsive to pressures on both cradle member 26 and rod handle support member 28. First, pressure on fishing rod 12 has the effect of lowering or raising fishing rod 12 in a vertical plane around self-adjusting positioning mechanism 86. Second, pressure upon or exerted by forearm 34 has the effect of lowering or raising forearm 34 in a vertical plane around self-adjusting positioning mechanism 86.

Self-adjusting positioning mechanism 86 includes pole handle support flange 38 (see FIG. 3) having opposed handle support flange inner and outer walls 88 and 90, respectively, with the terms inner and outer being defined as relative to torso 72, and further includes cradle flange 32 as having opposed cradle flange inner and outer walls 92 and 94, respectively, with the terms inner and outer being defined as relative to torso 72. As seen in FIG. 4, handle support member flange inner wall 88 is in juxtaposition with cradle support member flange outer wall 94. Handle support flange 38 defines a handle support member cylindrical chamber 96 having a handle support member chamber horizontal axis 98 extending transversely between inner and outer walls 88 and 90.

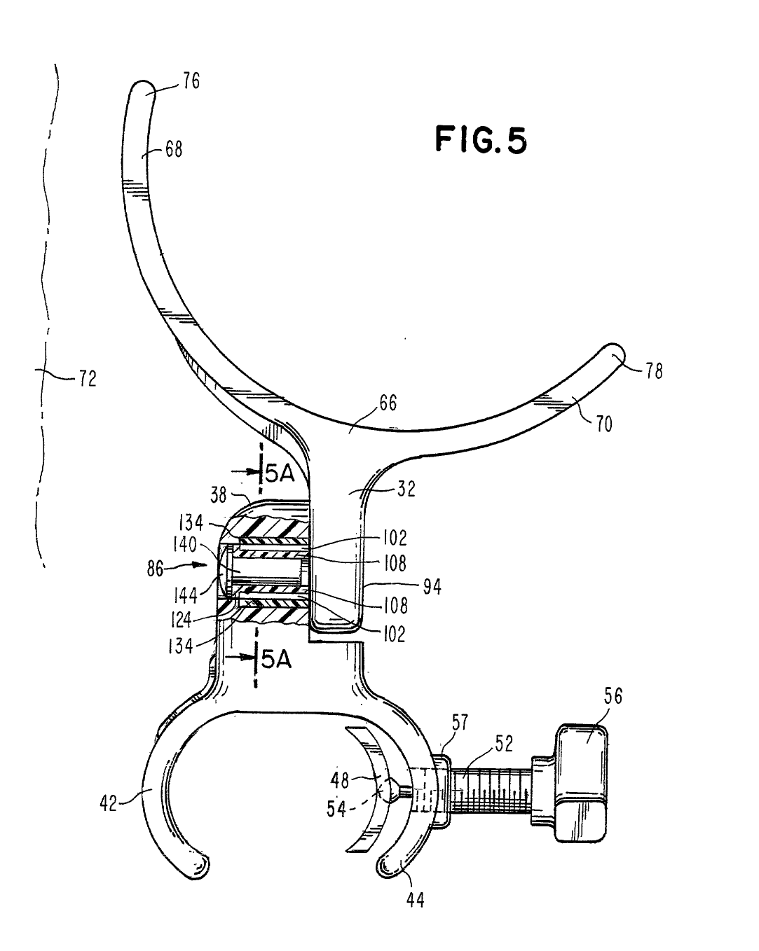

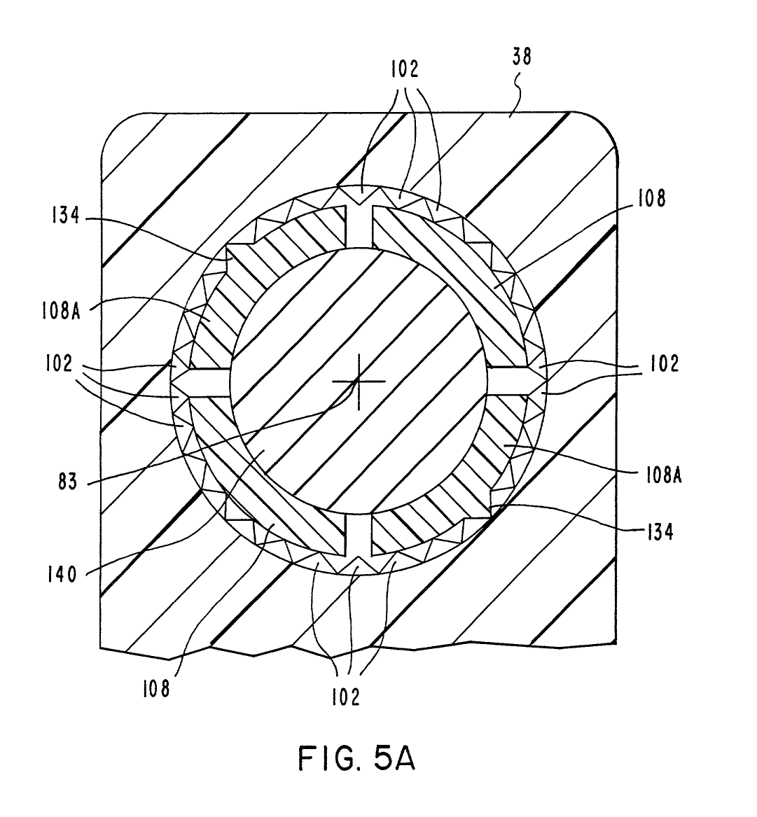

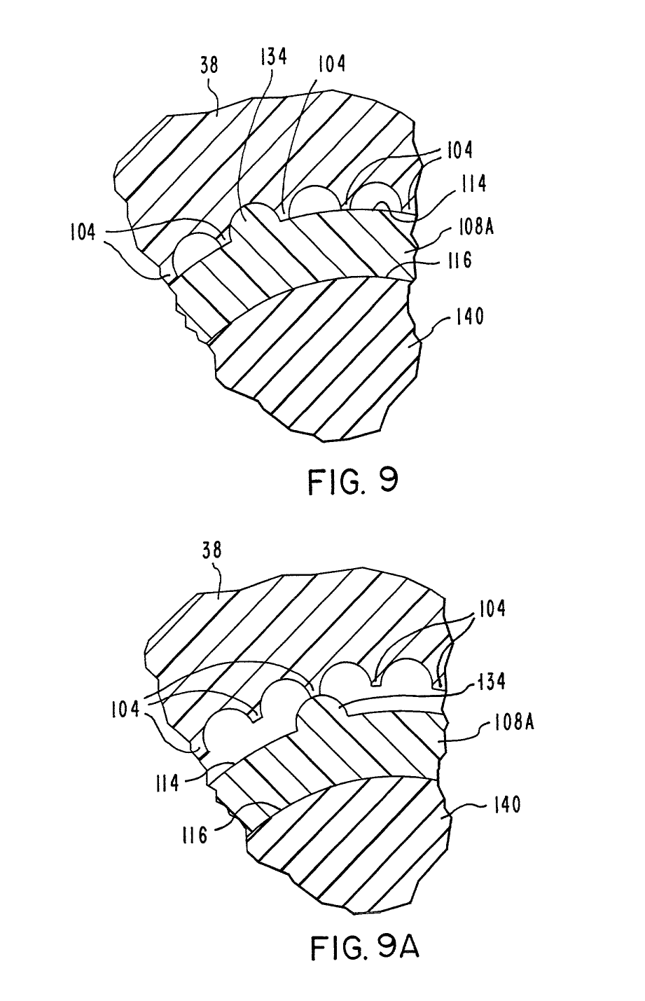

Self-adjusting positioning mechanism 86 as seen in FIGS. 5 and particularly 5A and also FIGS. 9, and 9A, also includes handle support member cylindrical chamber 96 having an inner cylindrical wall 100 that defines a plurality of parallel teeth 102 shown as 28 teeth in number for purposes of exposition only. As seen in FIGS. 9 and 9A, parallel teeth 102 have peaks 104 and valleys 106 in parallel alignment with handle support member chamber axis 98. Peaks 104 taken together generally define inner cylindrical chamber wall 100. Preferably, peaks 105 have flat apexes and valleys 106 are oval-shaped in cross-section.

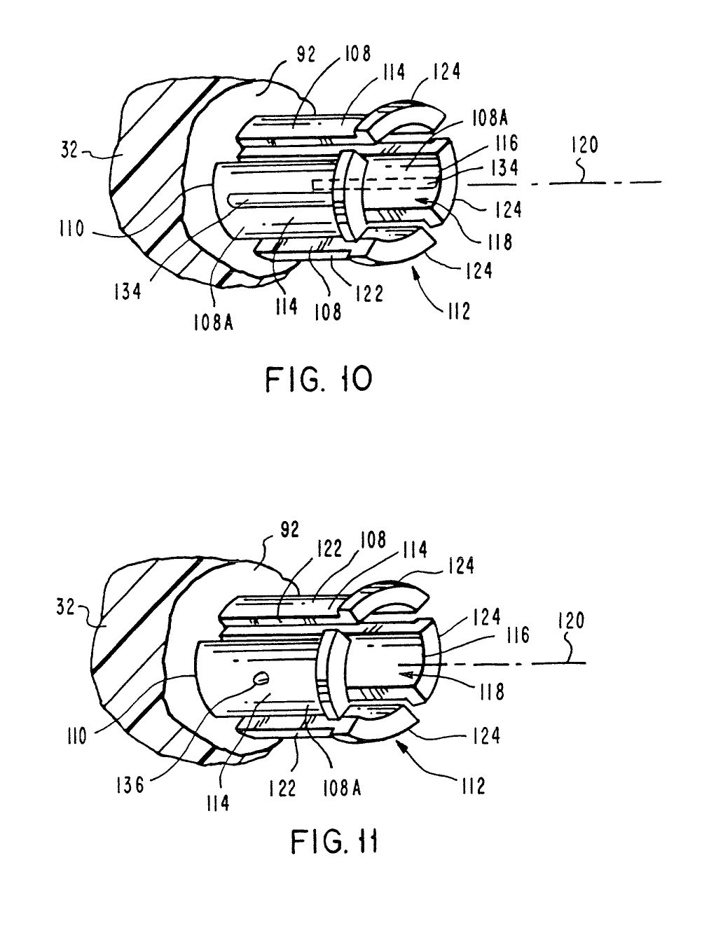

As shown in isolation in FIGS. 3 and 5A and in alternate configurations in FIGS. 10 and 11, cradle member 26 includes a plurality of fingers 108. Cradle member 26 includes, preferably, at least two fingers 108 or, more preferably, about four fingers 108. Each finger 108 has a finger connected end 110 joined to cradle support member flange inner wall 92 and an opposed finger free end 112.

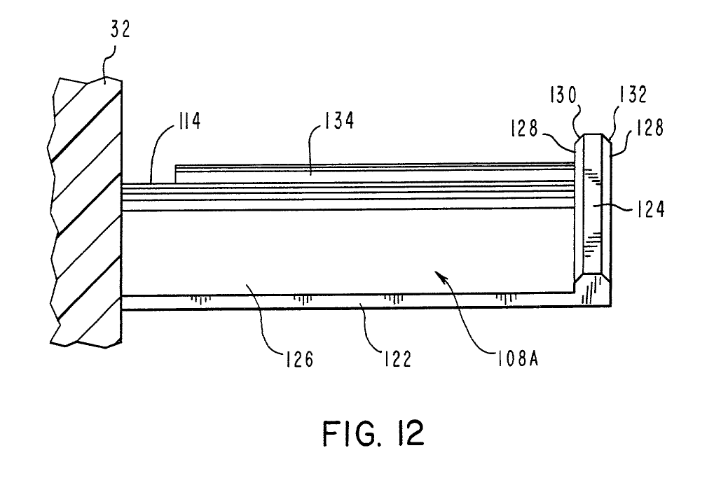

Fingers 108 are positioned within cylindrical chamber 96 in parallel relationship with handle support member chamber axis 98 and to parallel teeth 102. Each finger 108 has a finger outer annular, or arced, surface 114 conformed to fit in contact relationship with inner cylindrical chamber wall 100, that is to say, peaks 104 taken together when fingers 108 are in their unbiased mode. Each finger 108 further has a finger inner arced, or annular, surface 116 so that fingers 108 generally define a finger inner cylindrical compartment 118 indicated generally in FIG. 5A. Finger inner cylindrical compartment 118 has a horizontal compartment axis 120 that is aligned with rod support member chamber axis 98 and which together define the rotatable horizontal axis about which cradle member 26 and rod handle support member rotate relative to one another. As also shown in FIGS. 10 and 11, each finger 108 has a pair of opposed inwardly extending flat side walls 122 each indicated in FIG. 5A that join finger outer and inner annular surfaces 114 and 116 between connected ends 110 and free ends 112. As shown in FIGS. 5, 10, 11 and 12, each finger 108 has an arc-shaped finger flange 124 at each finger free end 112. As best seen in FIG. 12, a finger flange 124 representative of the four finger flanges 124 has a curved outer wall 126 and a flat end wall 128. Each finger flange 124 further has an inner taper 130 between finger outer annular surface 114 and flange outer wall 126 and a circumferential outer taper 132 between flange outer wall 126 and flange flat end wall 128.

Two opposed fingers 108, that is, two fingers 108 at 180° from one another, also additionally designated as fingers 108A in FIGS. 10 and 12, each include an elongated projecting element 134 that is connected to each outer annular surface 114 and that extends between each connected end 110 and each free end 112. Each elongated projecting element 134 is linear and oval in cross-section in configuration and extends parallel to handle support member chamber axis 98 and also to parallel teeth 102 between each finger connected end 110 and to each finger free end 112 in particular to each finger flange 124.

An alternate projecting element 136 shown in FIG. 11 is configured as a cylindrical button, or pin, projecting element that is connected to opposed fingers 112 also designated in particular as fingers 108B positioned on each outer annular surface 114 approximately midway between finger connected end 110 and finger free end 112. Pins 136 preferably have oval apexes.

As shown in FIGS. 9 and 9A, which are detailed areas of FIG. 10 showing elongated projecting element 134 and also of FIG. 11 showing button projecting element 134, each finger 108 and in particular each finger 108A or 108B is movable between an unbiased position as shown in FIG. 9 and a biased position as shown in FIG. 9A. In the unbiased position of fingers 108A and 108B, each of the two projecting elements 134 or 136, whichever as the case may be, is in a meshed relationship with teeth 102 in a particular valley 106, wherein cradle member 26 and rod handle support member 28 are locked together so that the angle A between cradle member 26 and rod 12 as shown in FIG. 13 remains unchanged.

In the biased mode of fingers 108A and 108B, projecting element 134 or 136, as the case may be, is in an unmeshed relationship with teeth 102 at a particular peak 104, wherein cradle member 26 and rod handle support member 28 are free to rotate relative to one another about aligned axes 98 and 120, that is, horizontal rotational axis 83, in response to pressure exerted by forearm 34 or fishing rod 12 to assume a new angle other than the angle A, that is to say, to a new angle that is greater than angle A such as angle B, or a new angle that is less than angle A such as angle C, both of the latter being shown in phantom line. Rotational movement of fishing rod 12 relative to forearm 34 retained by cradle member 26 about horizontal axis 83 caused by pressure initiated by a fish strike is also possible.

The force created by pressure from fishing rod 12 or from cradle member 26 by way of forearm 34 seeking a new comfort zone, or pressures from both sources of pressure, removes projecting element 134 or 136 as the case may be from the particular valley 106 in which it is positioned in the meshed relationship with teeth 102 shown in FIG. 9 for movement in one rotational direction or another about coextensive rod handle support chamber axis 98 and finger compartment axis 120 in response to the particular direction of the pressure. The biasing pressure that is required to move fingers 108A, or 108B, into a biased mode so as to assume the meshed relationship of teeth 102 and biasable fingers 108A or 108B shown in FIG. 9A. Resistance to any change of the meshed relationship between teeth 102 and biasable fingers 108A and 108B to an unmeshed relationship is measured by the degree of resistance to being moved from an unbiased mode to a biased mode. Fingers 108 can be made of any material such as certain metals or plastics. The angle A shown in FIG. 13 between fingers 108 and teeth 102 is maintained in a stable mode and only changed when the comfort zone of the forearm 34, wrist 64, and hand 63, such as that indicated in FIG. 13 as angle A, is challenged and ultimately overcome by external pressures and a new comfort zone is automatically sought so that self-adjustment positioning mechanism 86, characterized by the relationship between biasable fingers 108 and teeth 102, is activated to seek a new comfort zone until a new relationship between biasable fingers 108 and teeth 102 is achieved such as that indicated in FIG. 13 as angle B or angle C at which time the relationship between biasable fingers 108 and teeth 102, that is to say, self-adjusting positioning mechanism 86 itself, is stabilized until a new pressure sufficient to activate self-adjusting positioning mechanism 86 is applied.

As shown in FIG. 2 and in isolation in FIG. 3 and also in FIGS. 5 and 5A, a short plug 138 having a cylindrical plug body 140 and a oval plug cap 14 is mounted within finger cylindrical compartment 118, which in turn is mounted within cylindrical chamber 96 of rod handle support member flange 38. Plug 138 is made of a resilient material such as rubber or a resilient plastic material. Plug cap 144 overlies the rim of rod support member cylindrical chamber 96 at inner wall 90 rod handle support member support flange 38. As seen in FIGS. 5 and 5A and in detail in FIGS. 9 and 9A, finger inner annular surface 116 is pressed against cylindrical plug body 140. When each projecting element 134 or 136, as the case may be, is forced out of each valley 106 of teeth 102 when the pressure between cradle member 26 and handle support member 28 is such that self-adjusting positioning mechanism 86 becomes activated to the extent that biasable fingers 108A or 108B rotate out of valleys 106 and onto peaks 104 so that finger outer annualar surfaces 114 of biasable fingers 108A or 108B are pressed against and ultimately into resilient plug body 140 with the result that resilient plug body 140 flexes radially inwardly at the areas of mutual contact. As cradle member 26 and handle support member 28 continue to be rotated relative to one another in response to external pressure, biasable fingers 108A and 108B self-bias back into new valleys 106 and resilient plug body 140 thereupon resiliently resumes its former cylindrical configuration. Plug 138 has the function of preventing foreign material such as dirt or other from clogging the relationship between teeth 102 and biasable fingers 108. In addition, plug 134 can have self-biasing capability so as to optionally provide the function of creating additional resistance to undesired early disengagement between cradle member 26 and handle support member 28. Such resistance to disengagement between cradle member 26 and handle support member 28 is in addition to the resistance to such disengagement provided by biasable fingers 108 alone. Thus, added stability to self-adjusting positioning mechanism 86 is provided such that slight or inconsequential pressures do not cause unnecessary and disruptive rotational movement between cradle member 26 and handle support member 28. A locking mechanism (not shown) connected to opposed sides of rod handle support flange 38 at handle support flange inner wall 88 that overlays plug cap 144 and that removably secures plug 138 to handle support member 28 can optionally be provided.

As shown in FIG. 5A, cradle positioning mechanism 86 preferably has about twenty-eight rotational positions for self-adjusting positioning mechanism 86 are shown. Cradle positioning mechanism 86 further removably locks and unlocks cradle member 26 at one of the twenty-eight rotational positions relative to rod handle support member 28 in response to pressures exerted by forearm 34 so as to automatically select a comfortable position for forearm 34.

Adjustable arm support device 10 can be made of a strong plastic material or a suitable metal, preferably non-corrosive. Cradle member 26 and handle support member 28 are preferably made of the same material. Clamp mechanism 46 including clamp wall 48 and bolt 52 can be made of either plastic or metal.

Adjustable arm support device 10 can be disassembled from the assembled mode as shown, for example, in FIG. 2 to a disassembled mode shown in general in FIG. 3 so that it occupies a smaller storage volume than in the assembled mode thus enabling the disassembled device 10 to be fitted in a fisherman's kit box and then reassembled at a fishing site. Disassembly of device 10 is accomplished as follows. Plug 138 is first removed from finger compartment 118. Cradle member 26 and fishing rod handle support member 28 are pulled apart into the two separate entities as shown in FIG. 3. When finger flanges 124 are pressed against teeth 102, finger flange inner tapers 130 allows finger flanges 124 to slide over teeth 102 whereupon biasable fingers 108 are pressed into biased modes. Upon final removal of finger flanges 124 from handle member inner cylindrical chamber 96, that is, away from teeth 102, biasable fingers 108 spring back into unbiased modes and the separation of cradle member 26 and handle support member 28 is complete. Optional further disassembly of device 10 can include disassembly of clamp mechanism 46 including unthreading bolt 52 from clamp holding compartment outer side wall 44 and further from clamp wall 48.

Fishing rod handle grip 16 has a fishing rod handle diameter X₁ indicated in FIG. 4, and handle holding compartment inner side wall 42 has a first lower inwardly extending horned end 45A and handle holding compartment outer side wall 44 has a second lower inwardly extending horned end 45B in opposition to first lower horned end 45A. First and second lower horned ends 45B and 45B are spaced apart at a distance X₂ as indicated in FIG. 4 that is greater than the diameter of the diameter of fishing rod grip 16.

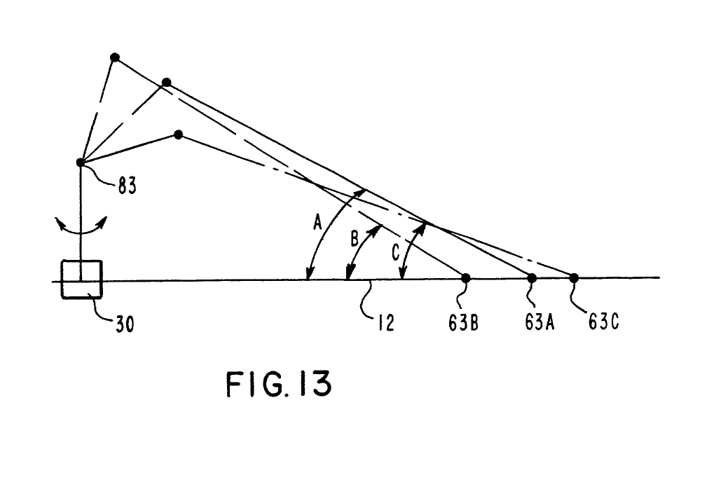

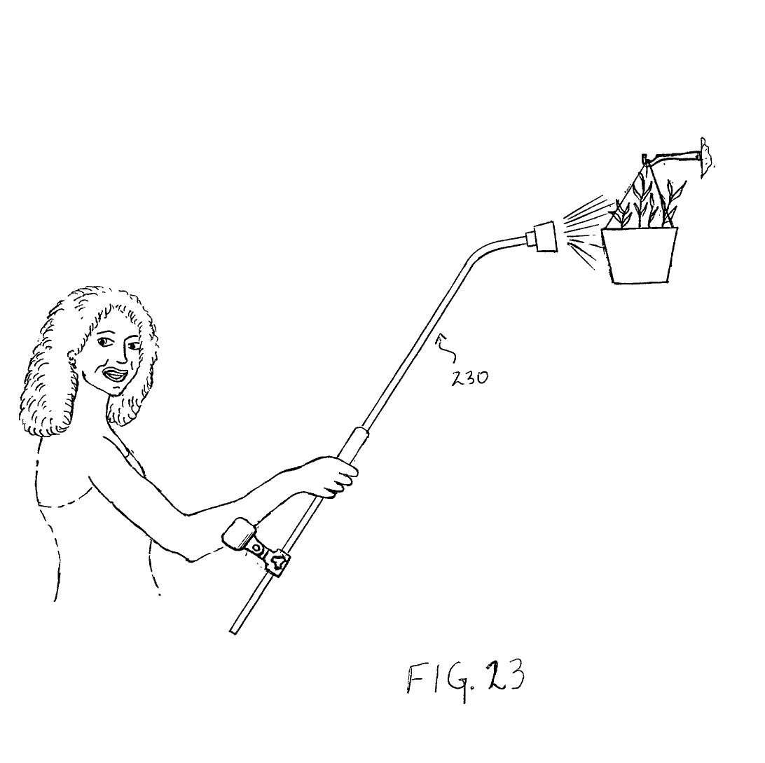

Referring to FIG. 14, adjustable arm support device 10 may be attached to any elongated, pole-shaped, and/or rod-shaped handle 15. Adjustable arm support device 10 may be fixedly or releasably attached to any appropriate handle using any appropriate fastening method and/or device. For example, as shown in FIG. 14, adjustable arm support device 10 may be provided with a base member having oppositely extending elements or wings for attachment to elongated handle 15 by nails, screws, glue, and/or other appropriate device. Alternatively, as shown in FIG. 15, adjustable arm support device 10 may be provided with a “split-cuff” or sleeve-type clamping member for encircling elongated handle 15, which may be be selectively loosened and tightened using one or more bands with screws or other appropriate device. As another example, as shown in FIG. 22, adjustable arm support device 10 may be provided with oppositely extending arcuate elements or arms for attachment to elongated handle 15 by a screw-type clamping member, as described above. Other appropriate fastening means for use in the present invention include, but are not limited to, welding, adhesives, tapes, and bindings.

Moreover, adjustable arm support device 10 may be integrally or seamlessly formed with elongated handle 15. For example, adjustible arm support device 10 and elongated handle 15 may be simultaneously and integrally molded using at least one thermoplastic material, such as high denisty polyethylene.

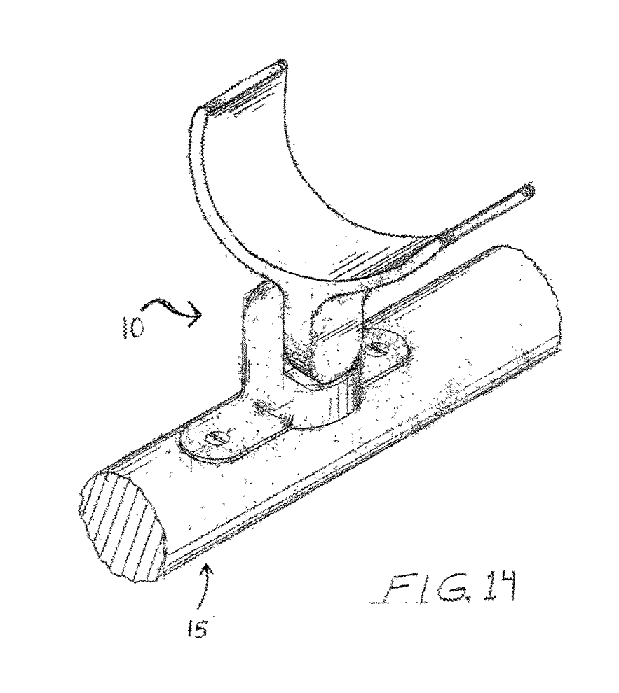

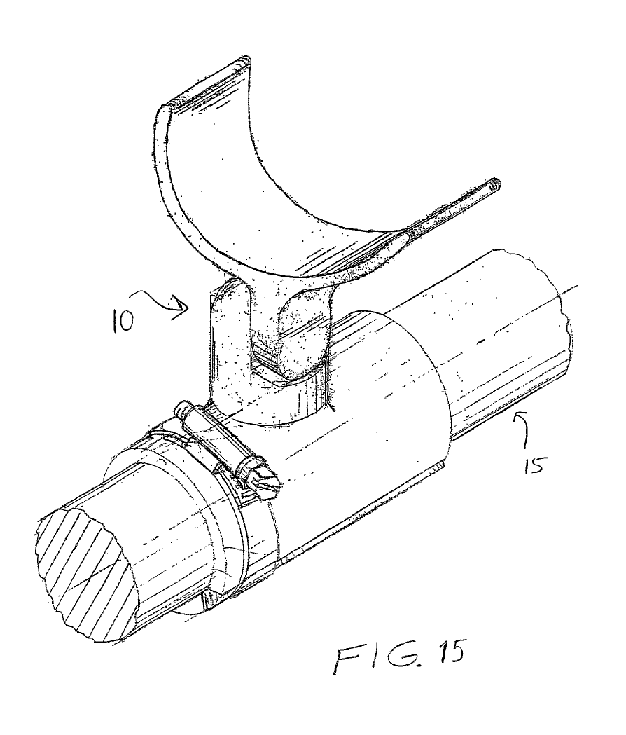

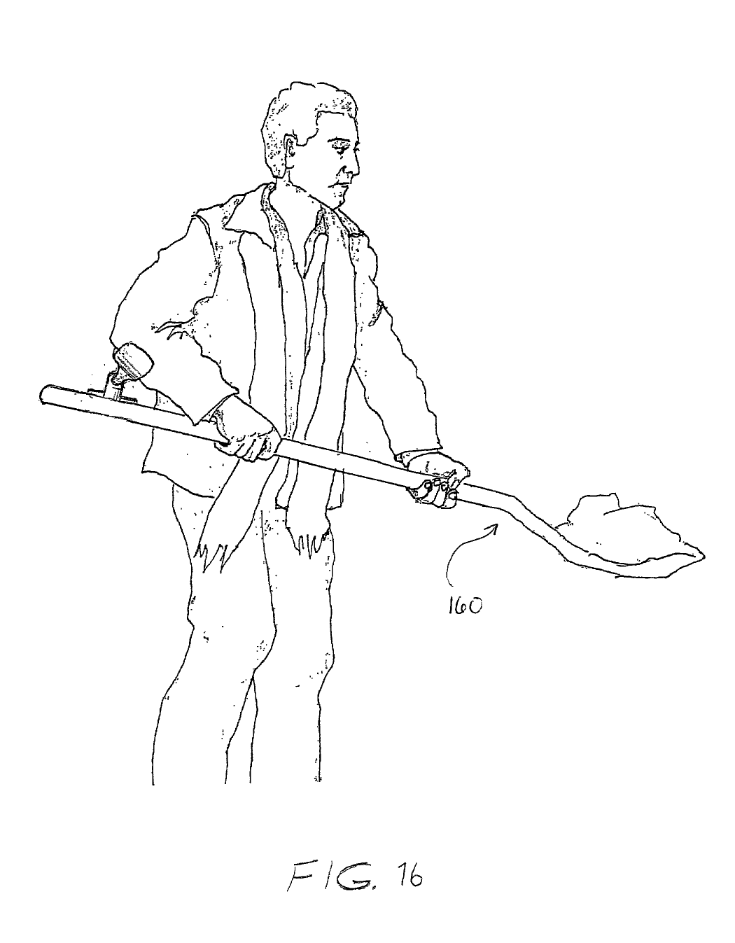

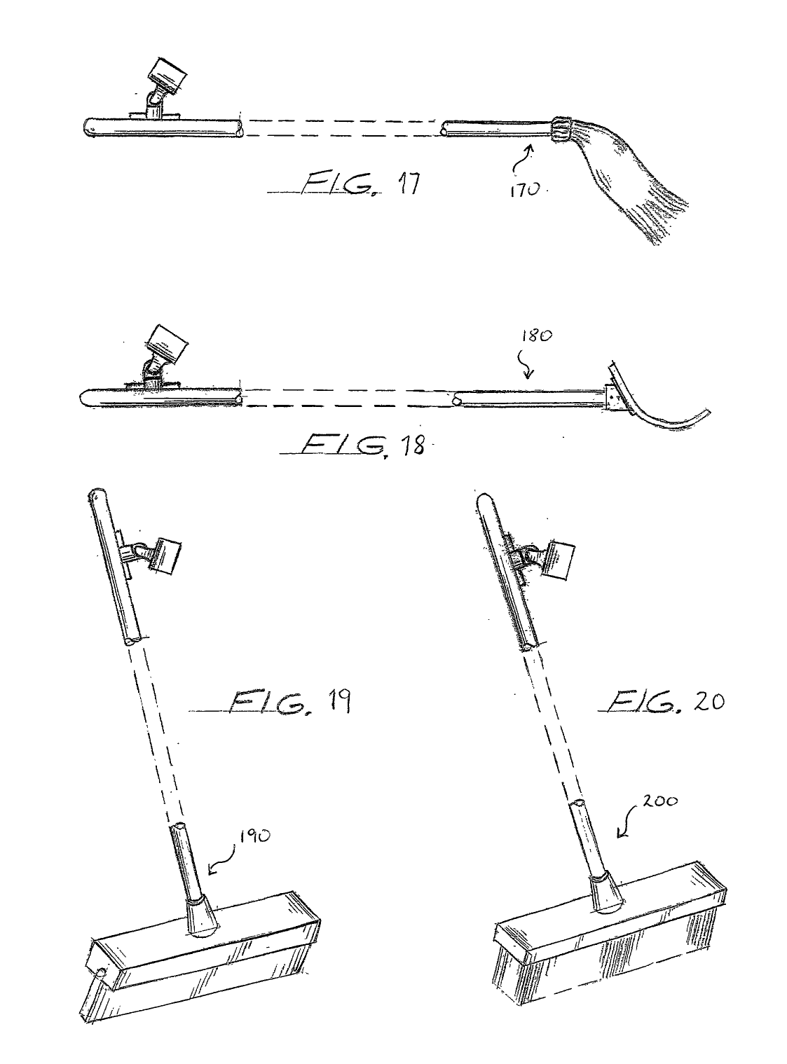

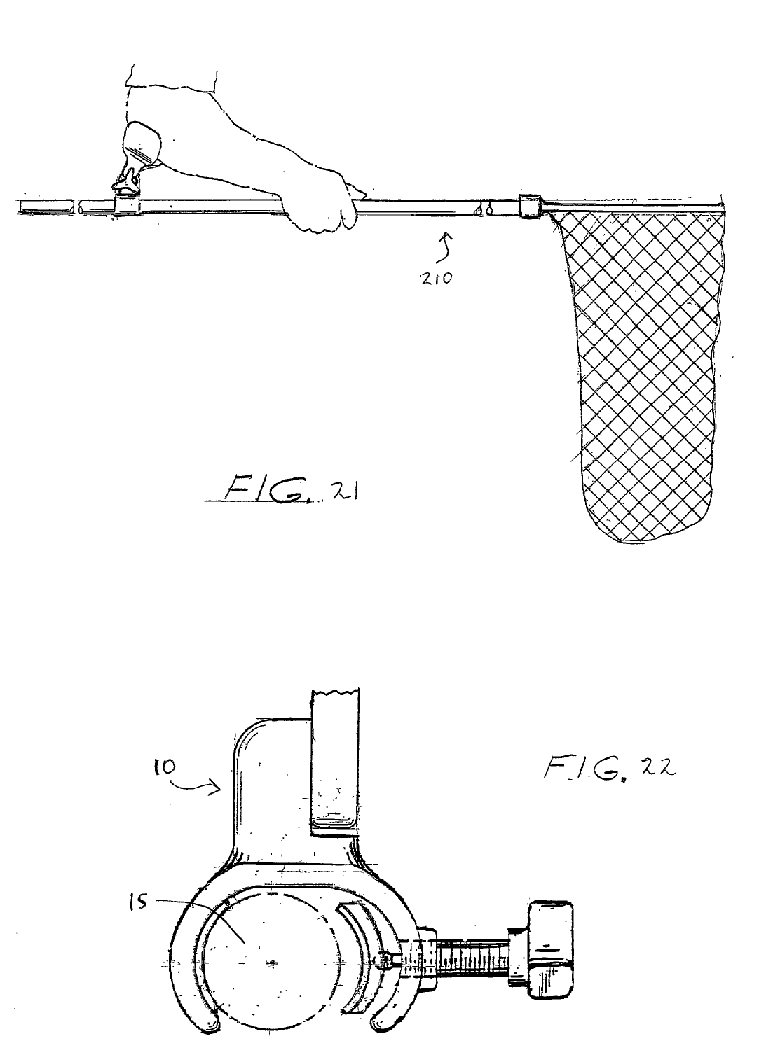

Exemplary tools having appropriate handles to which adjustable arm support device 10 may be fixedly and/or removeably attached include: dirt and/or snow shovels 160 (FIG. 16), mops 170 (FIG. 17), ice scrappers 180 (FIG. 18), brooms 200 (FIG. 20), fishing nets 210 (FIG. 21), fishing gaffs, rakes, pool skimmers, painter's poles, window washers and squeegees 190 (FIG. 19), hoes, crow bars, camera poles, tree saws and clippers, grass and/or weed trimmers and clippers, water sprayers and nozzles 230 (FIG. 23), and light bulb changers.

Adjustable arm support device 10 may be adapted to be fixedly and/or removeably attached to any type of elongated handle having any kind of cross-sectional shape, such as round, oval, rectilinear, polygonal, or square.

Referring again to FIG. 4, as stated above, rod handle gripping compartment axis 61 lies in a vertical gripping compartment axis plane 82. Cradle axis 74 lies in a vertical cradle axis plane 84 that is generally parallel to and horizontally distanced from vertical gripping compartment axis plane 82. Vertical gripping compartment axis plane 82 is located between the torso of the user (not shown) and vertical cradle axis plane 84. Vertical cradle axis plane 84 and vertical gripping compartment axis plane 82 are offset from one another by a distance D. Thus, the wrist of the user is positioned outwardly from rod handle 16 relative to the user's torso, so that the user's hand is naturally placed and wrapped around the underside of the elongated handle, which provides an ergonomic advantage. Offset distance D may be varied depending on the manner in which the elongated handle is typically held. Preferably, offset distance D is about 0.5 inch to 1.75 inches.

Referring again to FIG. 2, cradle inner and outer side wall portions 68 and 70 extend upwardly from their respective opposed sides of cradle bottom portion 66 so as together to form a arc-shape or partially tubular shape surrounding a central horizontal axis 74 and a transverse horizontal axis 74a perpendicular to central horizontal axis 74. Central horizontal axis 74 has also been referred to herein as cradle axis 74. The inner linear top edge 76 of cradle inner side wall portion 68 is preferably higher than the outer linear top edge 78 of cradle outer side arm portion 70. More preferably, inner top edge 76 is above transverse horizontal axis 74a, while outer top edge 78 is below transverse horizontal axis 74a.

Although the arm cradle of the present invention has been shown and described herein for supporting the right arm of a user, the arm cradle of the present invention is preferably adpated for universal application for either the right arm or the left arm. Since arm cradle 10 preferably has an intended orientation in which inner side wall portion 68 is taller than outer side arm portion 70, and arm cradle 26 is outwardly offset from handle grip 28, the appropriate orientation for arm cradle 10 could be obtained by reversing or rotating arm cradle 10 depending upon which arm the user desired to support.

The present invention has been described in some detail by way of example for purposes of clarity and understanding. It will, of course, be understood that various changes and modifications may be made in the form, details, and arrangements of the parts without departing from the scope of the invention set forth in the following claims.

What is claimed is:

1. A arm supporting device comprising:
cradle means for supporting the forearm of a user;
support means rotatably connected with said cradle means for holding an elongated handle in an alignment with said cradle means; and
self-adjusting positioning means for releasably locking said cradle means a rotational position relative to said support means, and for unlocking said cradle means from said rotational position, said self-adjusting positioning means operating in response to force translated to said self-adjusting positioning means from at least one of said cradle means and said support means.

2. The device according to claim 1, wherein said support means includes a releasable clamping means for releasably holding said elongated handle.

3. The device according to claim 2, wherein said releasable clamping means comprises a fixed side wall and an adjustable clamping member adapted to releasably hold said elongated handle against said fixed side wall.

4. The device according to claim 3, wherein said adjustable clamping member includes a threaded bolt extending through a threaded aperture defined by said fixed side wall, said threaded bolt having a inner end and an outer end, said inner end attached to a clamping wall for engaging said elongated handle, said outer end attached to a handle for turning said threaded bolt, whereby said threaded bolt may be selectively turned to releasable engage said clamping wall against said elongated handle and hold said elongated handle against said fixed side wall.

5. The device according to claim 2, wherein said releasable clamping means comprises an adjustable sleeve adapted to receive said elongated handle, and an adjustable clamping member adapted to compress said adjustable sleeve to grip said elongated handle.

6. The device according to claim 1, wherein said cradle means includes a cradle wall defining a partial cylinder with a first central horizontal axis, and wherein said support means includes a support wall having a second central horizontal axis, said first central horizontal axis being horizontally offset from said second horizontal axis, whereby a handle gripped by said handle support means will be offset from a user's forearm within said cradle means by an offset distance.

7. The device according to claim 6, wherein said offset distance is about 0.5 inch to about 1.75 inches.

8. The device according to claim 1, wherein said self-adjusting positioning means includes:
a chamber defined by chamber wall, said chamber having a central chamber axis, said chamber wall having a plurality of inwardly extending teeth defining a plurality of peaks and a plurality of valleys, said plurality of valleys in alignment with said central chamber axis; and
a biasable finger aligned with said central chamber axis and movable between an unbiased positioning and a biased position, said unbiased position disposing at least a portion of said biasable finger in one of said valleys in said chamber wall, whereby said cradle member and said handle support member are releasably locked, said biased position having said biasable finger in contact with one of said peaks, whereby said cradle member and said handle support member are rotatable relative to one another.

9. The device according to claim 1, wherein said chamber is disposed in said support means and said biasable finger extends from said cradle means into said chamber.

10. The device according to claim 1, wherein said support means has a support flange that defines said chamber, and wherein said biasable finger extends from a cradle flange disposed on said cradle means.

11. The device according to claim 1, wherein said biasable finger includes an outwardly extending rib elongated along said central chamber axis, and wherein said outwardly extending rib is disposed within one or said valleys when said biasable finger is in said unbiased position.

12. The device according to claim 1, wherein said biasable finger includes an outwardly extending nodule, and wherein said outwardly extending nodule is disposed within one or said valleys when said biasable finger is in said unbiased position.

13. The device according to claim 1, wherein said self-adjusting positioning means comprises a plurality of biasable fingers aligned with said central chamber axis and movable between an unbiased position and a biased position, said unbiased position disposing at least a portion of each of said plurality of biasable fingers in a respective one or said valleys in said chamber wall, whereby said cradle member and said handle support member are releasably locked, said biased position having each of said plurality of biasable fingers in contact with a respective one of said peaks, whereby said cradle member and said handle support member are rotatable relative to one another.

14. The device according to claim 13, wherein a selected number of said plurality of biasable fingers includes an outwardly extending rib elongated along said central chamber axis, and wherein said outwardly extending rib is disposed within one or said valleys when said biasable finger is in said unbiased position.

15. The device according to claim 13, wherein a selected number of said plurality of biasable fingers includes an outwardly extending nodule, and wherein said outwardly extending nodule is disposed within one or said valleys when said biasable finger is in said unbiased position.

16. The device according to claim 13, wherein at least a first one of said plurality of biasable fingers includes an outwardly extending rib elongated along said central chamber axis, wherein at least a second one of said plurality of biasable fingers includes an outwardly extending nodule, and wherein said outwardly extending rib and said outwardly extending nodule are each disposed within a respective one or said valleys when said biasable finger is in said unbiased position.

17. The device according to claim 1, wherein said cradle means comprises a cradle wall partially surrounding a central horizontal axis parallel to said cradle wall, said cradle wall having a first edge parallel to said central horizontal axis and disposed at a first vertical height, and a second edge parallel to said central horizontal axis and disposed at a second vertical height that is below said first vertical height.

18. The device according to claim 18, wherein said cradle wall is intersected by a transverse horizontal axis perpendicular to said central horizontal axis, wherein said first vertical height is above said transverse horizontal axis, and wherein said second vertical height is below said transverse horizontal axis.

19. The device according to claim 1, wherein said elongated handle is part of a tool selected from the group consisting of: dirt shovels, snow shovels, mops, ice scrappers, brooms, fishing nets, fishing gaffs, rakes, painter's poles, window washers, window squeegees, hoes, crow bars, camera poles, tree saws, tree clippers, grass trimmers, grass clippers, weed trimmers, weed clippers, water sprayers, water nozzles, and light bulb changers.
